(19) United States
(12) Patent Application Publication
(10) Pub. No.: US 2008/0182100 A1
(43) Pub. Date: Jul. 31, 2008

(54) MAGNETIC ANODIZED ALUMINIUM OXIDE WITH HIGH OXIDATION RESISTANCE AND METHOD FOR ITS FABRICATION

(75) Inventors: Wei Beng Ng, Singapore Science Park II (SG); Hiroyuki Okita, Singapore Science Park II (SG)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/761,676

(22) Filed: Jun. 12, 2007

(30) Foreign Application Priority Data
Jun. 15, 2006 (SG) 200603971-3

(51) Int. Cl. B32B 3/26; C25D 3/50; C25D 5/00

(52) U.S. Cl. 428/332; 205/80; 205/118; 205/257; 977/762

(57) ABSTRACT

A magnetic anodized aluminium oxide has a layer of anodized aluminium oxide forming a housing for an array of nanowires of a magnetic material formed in nanopores in the layer of anodized aluminium oxide. The nanowires have their side walls embedded in the nanopores in the layer of anodized aluminium oxide for preventing oxidation of the side walls. A corresponding method is also disclosed.

### CROSS REFERENCES TO RELATED APPLICATIONS

The present application contains subject matter related to Singapore Patent Application SG 200603971-3 filed in the Singapore Patent Office on Jun. 15, 2006, the entire contents of which being incorporated herein by reference.

### FIELD OF THE INVENTION

This invention relates to a magnetic anodized aluminium oxide with high oxidation resistance and to a method of manufacturing a magnetic anodized aluminium oxide and relates particularly, though not exclusively, to such a magnetic anodized aluminium oxide and a method of its manufacture able to resist oxidation in an atmosphere with oxygen, at an elevated temperature.

### BACKGROUND TO THE INVENTION

Oxidation is a serious problem in conventional metallic magnets such as rare earth magnets of niobium-iron-boron and samarium cobalt. Such oxidation is dominated by corrosion that occurs at their surfaces. If no protective coating is provided, oxygen diffuses into the surfaces of such a magnet, causing a metallurgical change in the surface layer. The consequence of oxidation of the surface layer is that the surface layer possesses a lower intrinsic coercivity. The lower coercivity allows the surface layer to be more easily demagnetized. At the same time, the formation of non-magnetic metallic oxides in the surface layer will lead to a reduction in the absolute magnetic flux that can be obtained from the magnet. It has been found that the oxidized surface layer varies as a function of both temperature and time. The higher the temperature or the longer the time, the greater will be the extent of oxidation.

Recently, electrodeposited cobalt-platinum (CoPt) based alloys have been studied as permanent micromagnets for application in magnetic microsystems. Among these, an alloy of cobalt-platinum-tungsten-phosphorus (CoPtWP) is a material the composition of which allows it to be electrodeposited to a high thickness—more than 20 um being possible—while maintaining the magnetic properties required for application in magnetic microdevices.

Although the electroplating of magnets is most often a room-temperature process, the fabrication of microdevices often involves elevated temperature steps such as, for example, wafer-level bonding. These are most often in air. Therefore, the thermomagnetic properties and oxidation resistance of the electrodeposited micromagnets are of importance for the application of such micromagnets. CoPtWP alloys suffer magnetic degradation due to oxidation after being subjected to temperature treatment in air. The formation of non-magnetic metallic oxides is an obstacle to the integration of electroplated magnets in microdevices as it reduces the magnetic flux density deliverable from the magnet. For example, the perpendicular remnant magnetization of a 5.4 um thick CoPtWP electroplated film decreases by ˜22% upon thermal treatment at 212° C.

To be able to achieve success in the application of electroplated magnets in microdevices, the electroplated magnets must be able to resist oxidation at elevated temperatures in air or other oxygen-rich atmosphere.

### SUMMARY OF THE INVENTION

According to a first preferred aspect there is provided a magnetic anodized aluminium oxide comprising a layer of anodized aluminium oxide forming a housing for an array of nanowires of a magnetic material formed in nanopores in the layer of anodized aluminium oxide. The nanowires may have their side walls embedded in the nanopores in the layer of anodized aluminium oxide for preventing oxidation of the side walls.

According to a second preferred aspect there is provided a magnetic anodized aluminium oxide comprising a layer of anodized aluminium oxide with nanowires of a magnetic material having their side walls embedded in nanopores in the layer of anodized aluminium oxide for preventing oxidation of the side walls. The nanowires may be in an array formed in micropores in the layer of anodized aluminium oxide.

For both aspects the magnetic anodized aluminium oxide may further comprise a seed layer of an electrically conductive material. The nanopores may be of a diameter of 70 nanometers, and the layer of anodized aluminium oxide may be of a thickness of 60 microns.

According to a third preferred aspect there is provided a method of forming a layer of magnetic anodized aluminum oxide, the method comprising electroplating a magnetic material into a layer of anodized aluminum oxide in an electrochemical bath.

The electrochemical bath may have a composition comprising: Co²⁺ ions in the range 0.001 to 0.5 mol/liter, PtCl₆²⁻ ions in the range 0.001 to 0.5 mol/liter, WO₄²⁻ ions in the range 0.001 to 0.5 mol/liter, and HPHO₃⁻ ions in the range 0.001 to 0.5 mol/liter; and may have a pH in the range 4.0 to 5.0.

Electroplating may be carried out at a current density in the range 1 to 1000 mA/cm². The layer of magnetic anodized aluminum oxide may be subjected to annealing in air in the range 100° C. to 400° C. The electroplating may be into nanopores of the layer of anodized aluminium oxide. The method may further comprise depositing a seed layer of an electrically conductive material before electroplating the magnetic material.

For all three aspects the magnetic material may be of an alloy containing cobalt in the range 45 to 95 atomic %, platinum in the range 0.5 to 50 atomic %, tungsten in the range 0.5 to 20 atomic %, and phosphorus in the range 0.5 to 10 atomic %.

### BRIEF DESCRIPTION OF THE DRAWINGS

In order that the invention may be fully understood and readily put into practical effect, there shall now be described by way of non-limitative example only preferred embodiments of the present invention, the description being by way of example only, and being with reference to the accompanying drawings.

In the drawings:

FIG. 1 is a scanning electron microscope (“SEM”) image showing the top view of an anodized aluminium oxide template;

FIG. 2 is a SEM image showing a cross-sectional view of the template of FIG. 1;

FIG. 3 is a SEM (back-scattered electron) image showing a cross-sectional view of CoPtWP nanowires embedded in an anodized aluminium oxide substrate;

FIG. 4 is a schematic diagram showing electroplated nanowires in an anodized aluminium oxide housing to form a magnetic anodized aluminium oxide material;

FIG. 5 is a graph of hysteresis curves of the material of FIGS. 3 and 4 before and after annealing at 320° C. for 2 hours in air;

FIG. 6 is a schematic diagram of the same mass of magnetic materials in two different forms: an unprotected planar film, and an array of nanowires within an anodized aluminium oxide housing; and

FIG. 7 is a plot showing the trend in remnant magnetization Mr and saturation magnetization Ms as a function of annealing time at 320° C. in air for both a plane film and nanowires in anodized aluminium oxide.

### DETAILED DESCRIPTION OF PREFERRED EMBODIMENTS

As shown in FIG. 4, an array 10 of magnetic nanowires 14 was embedded in anodized aluminum oxide 12 by electroplating into nanopores 22 in the anodized aluminum oxide 12 to form magnetic anodized aluminum oxide. The nanowires 14 are the hard magnetic phase of an alloy of CoPtWP. The alloy of CoPtWP preferably contains cobalt in the range 45 to 95 atomic %, platinum in the range 0.5 to 50 atomic %, tungsten in the range 0.5 to 20 atomic %, and phosphorus in the range 0.5 to 10 atomic %.

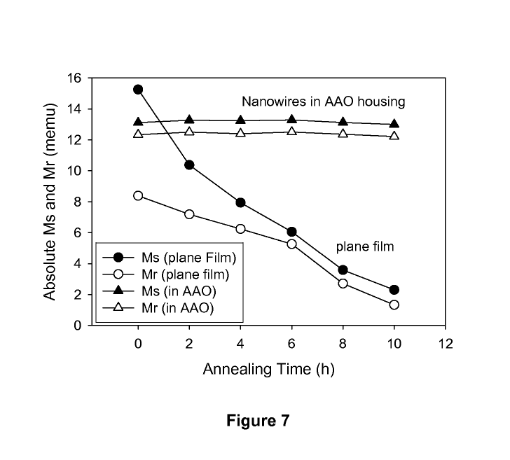

The housing formed by the anodized aluminum oxide 12 protects the thick, hard, magnetic material of the nanowires 14 against thermal oxidation. Thermal oxidation causes degradation of magnetic performance for applications at an elevated temperature in air. As shown in FIG. 7, the remnant magnetization, Mr, saturation magnetization, Ms, and squareness, S, in the out-of-plane direction of the magnetic anodized aluminum oxide 12 were unchanged before and after annealing at 320° C. in air and were maintained up to a minimum annealing duration of 10 hours under the same temperature and atmosphere. The initial and final Mr, Ms and S were ˜12 memu, 13 memu and 0.94 respectively.

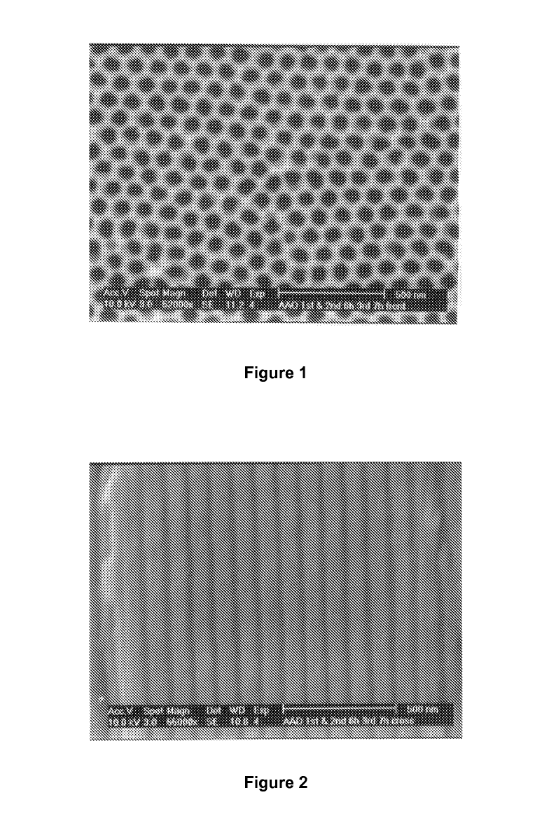

Anodized aluminum oxide 12 with about 70 nanometers pore diameter and 60 micron thickness was used as the template for electroplating. Scanning electron microscope (“SEM”) images of the top and cross-sectional views of the anodized aluminum oxide template are shown in FIGS. 1 and 2.

One side of the anodized aluminum oxide was sputtered with about 300 nm gold (Au) as a seed layer 16 for electroplating purposes. Another electrically conductive material such as, for example, silver or copper, could be used, if required or desired. Electrodeposition was carried out using a rotating disk electrode (“RDE”) system via a galvanostat/potentiostat. Ag/KCl was used as the reference electrode while pure platinum wire was used as the anode. The composition of the electrolyte solution for electroplating CoPtWP within the nanopores 22 of the anodized aluminum oxide 12 templates is given in Table 1. The solution was adjusted to a pH of 4.5 using NaOH and/or H₂SO₄. Electroplating conditions of current density and agitation speed are summarized in Table 1. In consideration of the overall plating area inclusive of the anodized aluminum oxide regions, current density was about 884 mA/cm².

TABLE 1

| | Concentration |
|---|---|
| Electrochemical Bath Composition | (Co—Pt—W—P) |
| B(OH)₃ | 0.4 mol/L |
| NaCl | 0.4 mol/L |
| CoCl₂•6H₂O | 0.01 mol/L |
| Na₂PtCl₆•6H₂O | 0.02 mol/L |
| Na₂WO₄•2H₂O | 0.003 mol/L |
| NaH₂PO₃•2.5H₂O | 2.5 g/L |
| Sodium Dodecyl Sulfate | 0.0096 g/L |
| Saccharin (Sodium based) | 1.0 g/L |
| Current Density | 0.25 A |
| Plated anodized aluminum oxide area | 6 mm diameter circle |
| Agitation (Rotation) Speed | 250 rpm |
| Bath Temperature | Room Temperature |
| Bath pH | 4.5 |

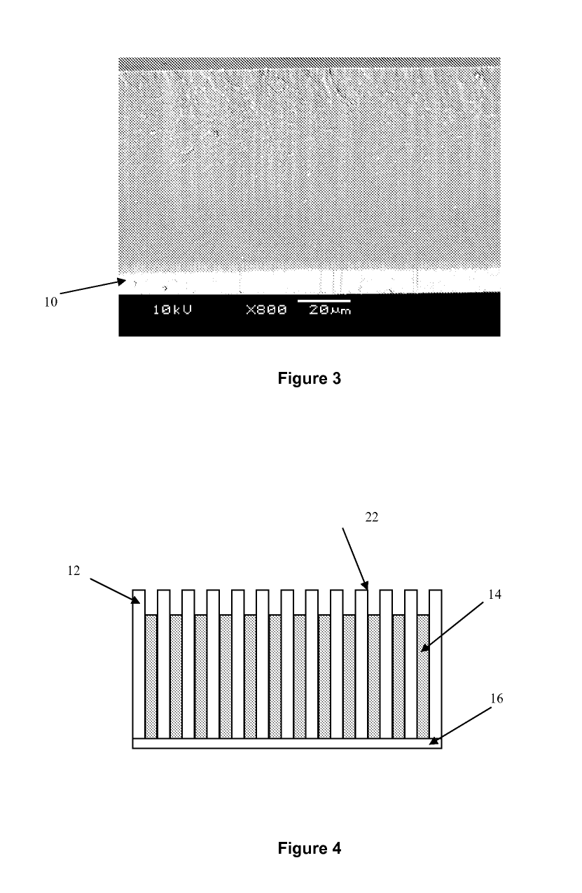

During electroplating, CoPtWP nanowires started growing from the bottom of the pores i.e. from the Au seed layer 16 along the nanopore channels 22 of the anodized aluminum oxide. As a result, arrays 10 of CoPtWP nanowires 14 are fabricated and embedded within the pores 22 of the anodized aluminum oxide 12 as shown by the SEM image of the cross-section in FIG. 3.

Thermal stability was carried out in ambient atmosphere at 320° C. for 2 hours for each thermal cycle. However, other times and temperatures may be used as required. For example, the temperature may be in the range 100° C. to 400° C. Cycling may be for a total of up to 10 or more hours. Magnetic hysteresis measured in a direction parallel to the nanowires, before and after the first 2 hours of annealing is shown in FIG. 5. Although the out-of-plane coercivity, Hc, dropped from 4.5 kOe to 3.4 kOe after the first annealing of 2 hours, it maintained at 3.4 kOe up to 10 hours of annealing at 320° C. in air.

Tables 2 and 3 summarize the changes in out-of-plane absolute saturation magnetization, Ms, absolute remnant magnetization, Mr, coercivity, Hc, and squareness, S, upon annealing with thermal cycles for CoPtWP in the form of a plane film and nanowires housed within anodized aluminium oxide, respectively. It can be observed that Ms and Mr dropped by as much as 84-85% for the case of plane film while there were hardly any changes for the nanowires within an anodized aluminium oxide housing. Although an improvement in Hc was observed initially for the plane film upon annealing, it started to drop beyond ˜6 hours. For the case of nanowires in an anodized aluminium oxide housing, though a drop in Hc was observed after the first thermal cycle, it remained constant for up to 10 hours of annealing.

TABLE 2

| Annealing Time | Abs. Ms | Abs. Mr | | |
|---|---|---|---|---|
| (h) | (memu) | (memu) | Hc (Oe) | S |
| 0 | 15.25 | 8.38 | 3733.27 | 0.55 |
| 2 | 10.37 | 7.18 | 4239.17 | 0.69 |
| 4 | 7.94 | 6.24 | 4318.45 | 0.79 |
| 6 | 6.05 | 5.26 | 4508.73 | 0.87 |
| 8 | 3.58 | 2.71 | 3620.40 | 0.76 |
| 10 | 2.30 | 1.33 | 2313.05 | 0.58 |

TABLE 3

| Annealing Time | Abs. Ms | Abs. Mr | | |
|---|---|---|---|---|
| (h) | (memu) | (memu) | Hc (Oe) | S |
| 0 | 13.11 | 12.33 | 4549.37 | 0.94 |
| 2 | 13.26 | 12.49 | 3432.04 | 0.94 |
| 4 | 13.23 | 12.39 | 3414.55 | 0.94 |
| 6 | 13.28 | 12.50 | 3433.39 | 0.94 |
| 8 | 13.12 | 12.36 | 3436.21 | 0.94 |
| 10 | 12.99 | 12.21 | 3446.36 | 0.94 |

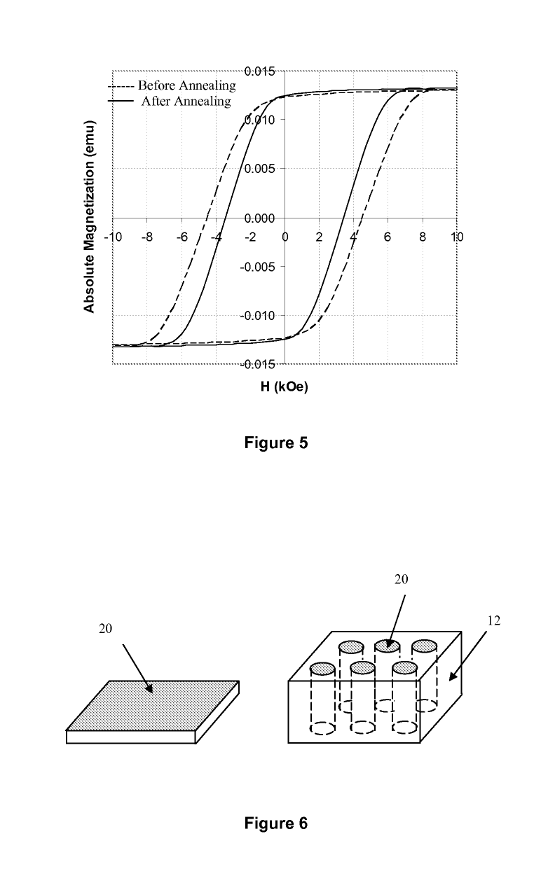

As shown in FIG. 6, typically oxidation of metallic components starts on the surface of materials. In the case of a plane film 18, the surface-to-volume ratio is high due to the large surface area but a small thickness. For the case of nanowires 10 embedded in an anodized aluminium oxide housing 12, the exposed area of the magnetic material 10 is only the top surface 20 of each nanowire 10 irregardless of the length of the nanowires 10. The side walls of the nanowires 10 are embedded in the anodized aluminium oxide 12 and are therefore not exposed to atmospheric oxygen, particularly during processes at elevated temperatures. As the side walls constitute the significantly greater surface area, this significantly reduces the surface area of the nanowires 10 exposed to atmospheric oxygen. In effect, the surface-to-volume ratio of the nanowires 10 in the anodized aluminium oxide 12 is significantly smaller compared to a plane film 18 of the same mass. As a result of the reduced surface area available for oxidation, the magnetic properties of the magnetic nanowires 10 are significantly preserved during temperature treatment.

As such, a magnetic anodized aluminium oxide with high oxidation resistance is able to resist oxidation in an atmosphere with oxygen, at an elevated temperature in a range such as, for example, 100° C. to 400° C. It may be about 320° C. The resistance to oxidation enables the magnetic component, in the form of electroplated CoPtWP nanowires in an array housed within the anodized aluminium oxide, to substantially maintain their original remnant magnetization. Therefore, they are able to substantially deliver the original absolute magnetic flux even after heat treatment up to about 320° C. in the presence of atmospheric oxygen.

Whilst there has been described in the foregoing description preferred embodiments of the present invention, it will be understood by those skilled in the technology concerned that many variations or modifications in details of design, construction or operation may be made without departing from the present invention.

1. A magnetic anodized aluminium oxide comprising a layer of anodized aluminium oxide forming an housing for an array of nanowires of a magnetic material formed in nanopores in the layer of anodized aluminium oxide.

2. A magnetic anodized aluminium oxide as claimed in claim 1, wherein the nanowires have their side walls embedded in the nanopores in the layer of anodized aluminium oxide for preventing oxidation of the side walls.

3. A magnetic anodized aluminium oxide comprising a layer of anodized aluminium oxide with nanowires of a magnetic material having their side walls embedded in nanopores in the layer of anodized aluminium oxide for preventing oxidation of the side walls.

4. A magnetic anodized aluminium oxide as claimed in claim 3, wherein the nanowires are in an array formed in micropores in the layer of anodized aluminium oxide.

5. A magnetic anodized aluminium oxide as claimed in any one of claims 1 to 4, wherein the magnetic material is of an alloy containing cobalt in the range 45 to 95 atm. %, platinum in the range 0.5 to 50 atm. %, tungsten in the range 0.5 to 20 atm. %, and phosphorus in the range 0.5 to 10 atm. %.

6. A magnetic anodized aluminium oxide as claimed in any one of claims 1 to 5, further comprising a seed layer of an electrically conductive material.

7. A magnetic anodized aluminium oxide as claimed in any one of claims 1 to 6, wherein the nanopores are of a diameter of 70 nanometers, and the layer of anodized aluminium oxide is of a thickness of 60 microns.

8. A method of forming a layer of magnetic anodized aluminum oxide, the method comprising electroplating a magnetic material into a layer of anodized aluminum oxide in an electrochemical bath.

9. A method as claimed in claim 8, wherein the electrochemical bath has a composition comprising: Co²⁺ ions in the range 0.001 to 0.5 mol/liter, PtCl₆²⁻ ions in the range 0.001 to 0.5 mol/liter, WO₄²⁻ ions in the range 0.001 to 0.5 mol/liter, and HPHO₃⁻ ions in the range 0.001 to 0.5 mol/liter.

10. A method according to claim 8 or claim 9, wherein the electrochemical bath has a pH in the range 4.0 to 5.0.

11. A method according to any one of claims 8 to 10, wherein electroplating is carried out at a current density in the range 1 to 1000 mA/cm².

12. A method according to any one of claims 8 to 11, wherein the layer of magnetic anodized aluminum oxide is subjected to annealing in air in the range 100° C. to 400° C.

13. A method as claimed in any one of claims 8 to 12, wherein the electroplating is into nanopores of the layer of anodized aluminium oxide.

14. A method as claimed in any one of claims 8 to 13 further comprising depositing a seed layer of an electrically conductive material before electroplating the magnetic material.

15. A method as claimed in any one of claims 8 to 14, wherein the magnetic material is of an alloy containing cobalt in the range 45 to 95 atm. %, platinum in the range 0.5 to 50 atm. %, tungsten in the range 0.5 to 20 atm. %, and phosphorus in the range 0.5 to 10 atm. %.
